(19) United States
(12) Patent Application Publication
(10) Pub. No.: US 2022/0252030 A1
(43) Pub. Date: Aug. 11, 2022

(54) High-Pressure Fuel Pump

(71) Applicant: Robert Bosch GmbH, Stuttgart (DE)

(72) Inventors: Christoph Buehler, Weissach (DE); Wolfgang Bueser, Benningen (DE); Markus Goeke, Hemmingen (DE); Thomas Fritzsche, Schwieberdingen (DE); Rainer Kornhaas, Stuttgart (DE); Lorenz Drutu, Moeglingen (DE); Lars Gonnermann, Schwieberdingen (DE)

(21) Appl. No.: 17/627,026

(22) PCT Filed: Jul. 6, 2020
(86) PCT No.: PCT/EP2020/068949

§ 371 Date: Jan. 13, 2022

(30) Foreign Application Priority Data
Jul. 19, 2019 (DE) 10 2019 210 702.8
Aug. 1, 2019 (DE) 10 2019 211 484.9
Jul. 1, 2020 (DE) 10 2020 208 228.6

(51) Int. Cl. F02M 63/02; F02M 63/00

(52) U.S. Cl. CPC F02M 63/0225; F02M 63/005; F02M 59/464; F02M 63/0054; F02M 63/0036

(57) ABSTRACT

A high-pressure fuel pump includes a pressure-limiting valve that opens from a high-pressure region of the high-pressure fuel pump towards a compression chamber or towards a low-pressure region of the high-pressure fuel pump. The pressure-limiting valve includes a valve body with a valve seat surface that tapers against the opening direction of the pressure-limiting valve, a spherical valve element, and a valve spring, which presses the spherical valve element against the opening direction of the pressure-limiting valve towards the valve seat surface. When the pressure-limiting valve is closed, the valve element and the valve seat surface bear against one another over a contact line, and a gap is formed between the valve element and valve body, next to the contact line. This gap is asymmetrically narrower upstream of the contact line than downstream of the contact line.

### PRIOR ART

High-pressure fuel pumps for fuel systems of internal combustion engines, for example for gasoline direct injection, are known from the prior art, for example from DE 2004 013 307 B4.

In these internal combustion engines, fuel is conveyed at high pressure from a fuel tank by means of a pre-feed pump and the mechanically driven high pressure pump into a high pressure reservoir (“rail”).

This high pressure pump has a pressure-limiting valve which prevents a pressure rising too sharply in the high pressure reservoir. If the pressure in the high pressure reservoir reaches a specific value, the pressure-limiting valve opens and fuel passes out of the high pressure reservoir back into the compression chamber or back into the low pressure chamber.

The pressure-limiting valve opens when the hydraulically acting force on one side of the valve element is greater than the opposing force of the spring pressing the valve element into the valve seat. The hydraulically acting force is produced from the prevailing hydraulic pressure and the surface on which the pressure acts. This surface results from the sealing diameter. In the case of a valve with, for example, an exactly conical or exactly domed valve seat surface and an exactly spherical valve element, the sealing diameter is produced as the diameter of the ideally linear support ring on which the ball is in contact with the valve seat surface.

If during operation of the high-pressure fuel pump wear occurs on the pressure-limiting valve, the support ring widens.

### DISCLOSURE OF THE INVENTION

The present invention is based on the recognition of the inventors that in principle the effective sealing diameter is determined according to the pressure drop actually occurring across the support ring.

The case has to be taken into account here in which the pressure-limiting valve is subjected to an opening pressure which is not sufficient to open the pressure-limiting valve macroscopically wide, but in which a certain, small but measurable leakage already occurs, for example a leakage of 1 ccm per minute in a pressure-limiting valve with a ball radius of 1 mm. For example, this observation relates to openings of the pressure-limiting valve in which the valve element lifts away from the valve seat surface in the order of magnitude 0.5 μm or 1 μm or approximately a thousandth of the ball radius of the valve element, so that a gap or leakage gap is formed between the valve element and the valve body. This situation under consideration is regarded as representative of the actual circumstances responsible for the opening of a pressure-limiting valve of a high- pressure fuel pump. In particular, an opening pressure of a pressure-limiting valve may be defined in this manner.

The present invention is also based on the observation of the inventors that in conventional pressure-limiting valves in which a gap is formed between the valve element and the valve body in a symmetrical manner, during the course of wear on the valve seat surface it always leads to an increase in the effective sealing diameter and as a result with a given pressure in the high pressure range it leads to an increase in the opening force acting on the valve element. In the case of the valve element being acted upon again by the valve spring to a given degree in the closing direction, the opening pressure of the pressure-limiting valve thus reduces and the high-pressure fuel pump is no longer able to generate or maintain the original fuel pressure.

It has also been recognized that these undesired effects are avoidable if the conventional pressure-limiting valve is developed in such a manner that it does not lead to an increase in the effective sealing diameter during the course of wear.

This may be achieved according to the invention, when the pressure-limiting valve is closed, by the gap formed between the valve element and the valve body next to the contact line being asymmetrically narrower upstream of the contact line than downstream of the contact line.

In this case a “contact line” is understood to mean initially a line in the mathematically idealized sense, i.e. a line, in this case an annular line having the width “zero”. It goes without saying, however, that within the meaning of the application a contact line may also be understood to mean bearing surfaces, here annular bearing surfaces, with a width which is small but different from zero, which in particular result from the force with which the valve element presses against the valve body, and the resilience of the valve element and the valve body and/or in particular from the deformations of the valve element and/or the valve body in the context of wear phenomena. Preferably, however, the linear or planar contact geometry between the valve element and the valve body which exists before wear phenomena, in particular before a first operation or before a first permanent operation of the high-pressure fuel pump, is understood as the contact line.

In this case, “upstream of the contact line” and “downstream of the contact line” are understood to mean, in particular, only the region of the valve seat surface actually relevant for the wear phenomena, i.e. for example 500 μm in or against the opening direction of the pressure-limiting valve, or for example half a radius of the valve ball in or against the opening direction of the pressure-limiting valve. Thus accordingly the features according to the invention, in particular, are already implemented within this region and, in particular, are advantageous within this region for achieving the effects according to the invention. In particular, the geometry of the gap between the valve element and the valve body outside this region is not relevant for wear phenomena. Asymmetries of the geometry of the gap only outside this region of the valve seat surface which is actually relevant for wear phenomena would in this regard not remedy the aforementioned drawbacks of the prior art.

Within the context of the present application, the gap being asymmetrically narrower upstream of the contact line than downstream of the contact line is understood to mean, in particular, that a spacing between the valve element and the valve body at a certain distance upstream (i.e. against the opening direction of the pressure-limiting valve) of the contact line is smaller than a spacing between the valve element and the valve body in this certain distance downstream (i.e. in the opening direction of the pressure-limiting valve) of the contact line. As already mentioned, in particular, it may be advantageous that the certain distance is located inside the region relevant for wear phenomena, for example inside 500 μm in or against the opening direction of the pressure-limiting valve or, for example, within half a radius of the valve ball in or against the opening direction of the pressure-limiting valve.

Within the context of the present application, the gap being asymmetrically narrower upstream of the contact line than downstream of the contact line is understood to mean, in particular, that a spacing between the valve element and the valve body inside the region relevant for wear phenomena for all distances above a minimum distance upstream (i.e. against the opening direction of the pressure-limiting valve) of the contact line is in each case smaller than a spacing between the valve element and the valve body in this distance downstream (i.e. in the opening direction of the pressure-limiting valve) of the contact line. The minimum distance may be, for example, 300 μm or, for example, 30% of the radius of the valve ball.

The term “narrower” is also understood to mean in principle the relation between two length-like dimensions which is also colloquially addressed hereby. In the present case, in particular, it may be assumed that the gap is narrower at its narrower position, due to the basic shape of the valve element and the valve body, and not only due to a surface roughness of the valve element and the valve body. It may be assumed, for example, that a gap at its “narrower” position is narrower by at least 5 pm or at least 0.5% of the radius of the valve ball than the gap at the comparison position.

As the gap according to the invention downstream of the contact line (where the sealing diameter is thus greater than on the contact line) is less narrow, a smaller pressure drop occurs here in the case of leakage. If the contact line between the valve ball and the sealing seat surface now widens during the course of wear, such that the less narrow gap region is increasingly relevant hydraulically, this has only a reduced effect of increasing the effective sealing diameter.

Since—on the other hand—the gap according to the invention upstream of the contact line (where the sealing diameter is smaller than on the contact line) is narrower, a greater pressure drop occurs here in the case of leakage.

If the contact line now widens between the valve ball and the sealing seat surface during the course of wear, such that the narrower gap region is more relevant hydraulically, this has an effect of reducing the effective sealing diameter.

An increase in the effective sealing diameter is thus counteracted by the embodiment according to the invention and a reduction in the opening pressure of the high-pressure fuel pump does not occur or only to a reduced extent, even in the case of wear. The high-pressure fuel pump is able to generate and maintain an unreduced high pressure over its entire service life.

The high-pressure fuel pump according to the invention thus makes a contribution to fuel supply systems for internal combustion engines which over their entire service life have no impaired performance and emissions parameters, or only impaired to a very slight extent.

A separate subject of the invention, in addition to a high-pressure fuel pump which has the described pressure-limiting valve, is also the pressure-limiting valve per se which is for use in the described high-pressure fuel pump.

Developments of the invention specify the geometry of the valve body and the valve seat surface and the gap formed between the spherical valve element and the valve body by means of advantageous features.

Thus it may be provided that the valve seat surface on an edge of the valve body strikes a further surface of the valve body arranged downstream of the contact line, wherein the further surface is inclined further away from the opening direction (i.e. the axis of symmetry) of the pressure-limiting valve than the valve seat surface, and wherein the contact line is located, in particular, in the region just upstream of the edge of the valve body on the valve seat surface, wherein the contact line, however, in particular is not located immediately upstream of the edge of the valve body on the valve seat surface.

In this development, therefore, the further surface of the valve body, which is separated from the valve seat surface by the edge, equally represents a radially outwardly widened or outwardly angled extension of the valve seat surface of the valve body. Whilst the gap between the valve element and the valve body in the entire downstream region between the contact line and the edge may be equally symmetrically narrow, as in the corresponding region upstream of the contact line, the gap between the valve element and the valve body, in particular viewed from the contact line in the region located on the other side of the edge, is less narrow, i.e. further upstream of the contact line than the gap at the corresponding position.

Since the further surface is inclined further away from the opening direction of the pressure-limiting valve, i.e. further radially outwardly than the valve seat surface, it may be expressed that the further surface and the valve seat surface come into contact with one another on the edge at an angle which (as the internal angle of the valve body in a plane measured through the axis of symmetry) is less than 180°, for example not greater than 175° or even not greater than 150°.

So that the edge for the opening behavior of the pressure-limiting valve is particularly advantageously effective, it may be provided that the contact line is located in the region just upstream of the edge of the valve body on the valve seat surface. In the case of wear, in which the contact line between the valve element and the valve body as described above widens to form a wear region, this wear region then reaches the edge after a certain operating time of the high-pressure fuel pump. If the wear continues, the wear region still spreads in the upstream direction, but in the downstream direction the spreading of the wear region is hindered by the edge and the orientation of the further surface. Thus the effective sealing diameter no longer increases, or only to a reduced extent, and the opening pressure of the pressure-limiting valve remains substantially constant or in the desired range.

The region just upstream of the edge may extend, for example, merely up to 500 μm or, for example, merely up to half a radius of the valve ball in the direction upstream of the edge.

It may be provided that the contact line is located outside the region directly upstream of the edge of the valve body on the valve seat surface. A contact line which is located directly upstream of the edge of the valve body, i.e. for example is located on the edge of the valve body, has the drawback that after a wide opening of the pressure-limiting valve, whenever the valve ball returns into the valve seat with a certain axial offset, i.e. with a certain offset to the axis of symmetry of the pressure-limiting valve, the valve ball strikes the edge, for example, at merely one point of impact and thus there is the risk that at this point of impact it leads to damage of the valve seat and thus to leakages of the pressure-limiting valve.

The region directly upstream of the edge of the valve body may extend, for example, merely up to 25 μm or merely up to 50 μm or, for example, merely up to 2.5% or merely up to 5% of the radius of the valve ball upstream of the edge of the valve body.

In particular, the further surface of the valve body may be oriented perpendicular to the opening direction of the pressure-limiting valve. This geometry is particularly effective and also particularly simple to produce.

On the other hand, it may be provided that the valve seat surface is shaped to form a recess of the valve body downstream of the contact line, between the valve element and the valve seat surface of the valve body.

A valve seat surface which is shaped in some regions to form a recess is understood to mean a valve seat surface which may be produced by material being removed from the inner contour of the valve body starting from the basic shape of the inner contour of the valve body (for example conical, domed, etc.).

For example, this may be implemented by the recess being a rectangular recess, i.e. it consists of an annular planar surface which is perpendicular to the opening direction of the pressure-limiting valve, and an adjoining cylindrical surface which is parallel to the opening direction of the pressure-limiting valve.

The annular surface may have, for example, a width of at least 100 μm or 10% of the radius of the valve ball; the cylindrical surface may have, for example, a height of at least 100 μm or 10% of the radius of the valve ball.

So that the recess for the opening behavior of the pressure-limiting valve is particularly advantageously effective, it may be provided that the contact line is located in the region just upstream of the recess of the valve body on the valve seat surface. In the case of wear, in which the contact line between the valve element and the valve body as described above spreads to a wear region, then this wear region reaches the recess after a certain operating time of the high-pressure fuel pump. If the wear continues further, the wear region spreads further in the upstream direction, but the spread of the wear region in the downstream direction is substantially prevented by the recess. The effective sealing diameter no longer increases as a result, or is merely reduced, and the opening pressure of the pressure-limiting valve remains substantially constant or in the desired range.

The region just upstream of the recess may extend, for example, only up to 500 μm or, for example, only up to half a radius of the valve ball in the direction upstream of the edge.

Downstream of the recess, in particular, the basic shape of the inner contour of the valve body may continue in the same manner as upstream of the recess, i.e. for example in a conical, domed manner, etc. Upstream of the recess, therefore, the inner contour of the valve body is located on the same conical surface or on the same dome as downstream of the recess.

The valve seat surface may have, for example, a conical or domed shape, or a conical or domed basic shape, wherein additionally a recess is formed in the valve seat surface.

Other asymmetrical designs of the valve seat surface or the inner contour of the valve body, which taper at least in a region around the contact line against the opening direction of the pressure-limiting valve, are also possible in principle.

It may be provided that the valve seat surface has a domed shape so that the gap between the domed valve seat surface and the spherical valve element upstream of the contact line is greater than zero and as small as possible.

Although in this development a particularly small dimension is desired in principle, a zero dimension is excluded in order to ensure a defined contact between the valve seat surface and the valve ball or a defined contact line therebetween.

For example, it may be provided that the gap between the domed valve seat surface and the spherical valve element upstream of the contact line is greater than zero and at its widest point narrower than 50 μm, in particular even narrower than 10 μm and/or narrower than 3 μm.

Such a narrow gap has the advantage that, starting from the new state of the pressure-limiting valve and already after a short operation and with little wear, the contact line rapidly spreads to a contact region which extends over a large part of the domed valve seat surface or even over the entire domed valve seat surface. This leads to a certain, but controlled, change according to the invention of the effective sealing diameter.

The spherical valve element then comes to bear against the valve seat surface in the large contact region. With a further increase in the wear volume, then the effective sealing diameter only changes slightly.

In order to minimize the effects of wear, the valve body may consist of hardened steel. In particular, the inner contour of the valve body, in particular the valve seat surface, constitutes a hardened edge layer, for example by carburizing or nitrocarburizing, or the like. In the context of the present invention it was able to be observed by the inventors that the provision of such a hardened edge layer not only reduces the wear in principle but may also increase an already initially existing asymmetry of the gap between the valve element and the valve body during the course of the operation of the high-pressure fuel pump and the wear associated therewith, which in turn acts synergistically with the advantageous effect of the invention.

In particular, in the case of a hardened valve seat surface or hardened edge layer of the valve body, it may also be provided that the valve ball or at least the surface of the valve ball is even harder than the valve seat surface or the hardened edge layer of the valve body. The valve ball may consist, for example, of hard metal (tungsten carbide) and/or of a ceramic, for example silicon nitride. The wear then substantially only occurs on the valve body but not on the valve element, which in this regard is synergistic within the present invention, such that this already has the effect that this wear specifically occurring only on the valve body does not impair, or only slightly impairs, the function of the high-pressure fuel pump.

### DRAWING

FIG. 1a shows a simplified schematic view of a fuel system for an internal combustion engine.

FIG. 1b shows a longitudinal section through the pressure-limiting valve of the high-pressure fuel pump of the fuel system of FIG. 1a.

FIGS. 2a and 2b show enlarged longitudinal sections through a pressure-limiting valve not according to the invention in a state in which wear has not yet taken place (FIG. 2a) and in a state in which wear has already taken place (FIG. 2b).

FIGS. 3a and 3b show enlarged longitudinal sections through a first exemplary embodiment of a pressure-limiting valve modified according to the invention in a state in which wear has not yet taken place (FIG. 3a) and in a state in which wear has already taken place (FIG. 3b).

FIG. 4 shows the functionality of pressure-limiting valves according to the invention according to FIGS. 3a and 3b in comparison with pressure-limiting valves not according to the invention in the case of wear.

FIGS. 5a, 5b and 5c show enlarged longitudinal sections through a second exemplary embodiment of a pressure-limiting valve modified according to the invention in a state in which wear has not yet taken place (FIG. 5a) and in a state in which wear has already taken place (FIGS. 5b and 5c).

FIG. 6 shows a third exemplary embodiment.

FIGS. 7a, 7b and 7c show a fourth exemplary embodiment.

### DESCRIPTION OF THE EXEMPLARY EMBODIMENTS

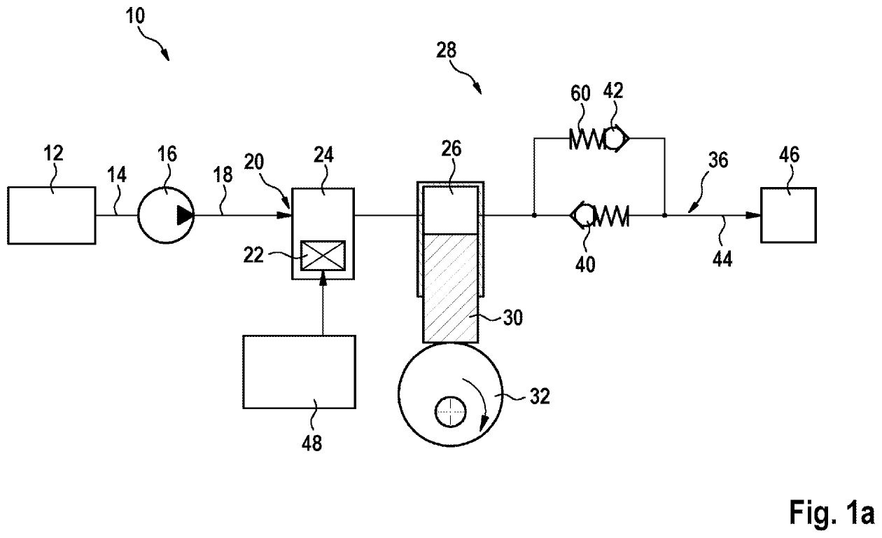

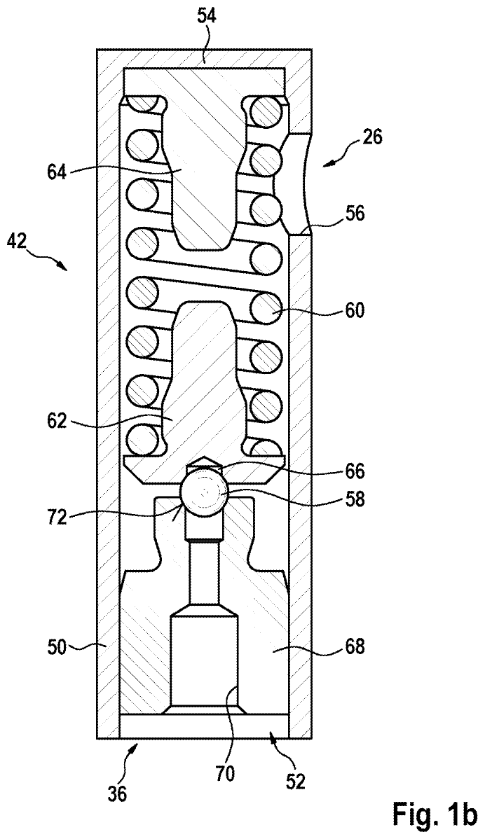

FIG. 1a shows a fuel system 10 for an internal combustion internal combustion engine, not shown further, in a simplified schematic view. A fuel such as gasoline is supplied from a fuel tank 12 via a suction line 14 by means of a pre-feed pump 16, via a low pressure line 18, via an inlet 20 of a quantity control valve 24, which is actuatable by an electromagnetic actuating device 22, to a compression chamber 26 of a high-pressure fuel pump 28. For example, the quantity control valve 24 may be a forced opening inlet valve of the high-pressure fuel pump 28.

In the present case, the high-pressure fuel pump 28 is designed as a piston pump, wherein a piston 30 may be moved by means of a cam disk 32 vertically in the drawing. An outlet valve 40, illustrated in FIG. 1a as a spring-loaded check valve, and a pressure-limiting valve 42, also illustrated as a spring-loaded check valve, are arranged hydraulically between the compression chamber 26 and an outlet 36 of the high-pressure fuel pump 28. The outlet 36 is connected to a high pressure line 44 and thereby to a high pressure reservoir 46 (“common rail”).

The outlet valve 40 may open toward the outlet 36 and the pressure-limiting valve 42 may open toward the compression chamber 26. The electromagnetic actuating device 22 is activated by a control and/or regulating device 48.

Deviating from the view of FIG. 1a, instead of being connected to the compression chamber 26, a left-hand port of the pressure-limiting valve 42 in FIG. 1a may alternatively be connected to a low pressure region of the high-pressure fuel pump 28 or any other element upstream of the high-pressure fuel pump 28.

During the operation of the fuel system 10, the pre-feed pump 16 conveys fuel from the fuel tank 12 into the low pressure line 18. The quantity control valve 24 may be closed and opened as a function of a respective requirement for fuel. As a result, the quantity of fuel conveyed to the high pressure reservoir 46 is influenced.

In a normal case, the pressure-limiting valve 42 is closed. If in an operating case deviating from the normal case a fuel pressure in the high pressure line 44 is greater than a fuel pressure in a region of the compression chamber 26 (relative to a spring force of a valve spring 60 of the pressure-limiting valve 42, see also FIG. 1b), the pressure-limiting valve 42 opens. Fuel then flows out of the high pressure line 44 back into the compression chamber 26 and from there optionally back into the low pressure line 18. As a result, the fuel pressure in the high pressure line 44 may drop to a permitted value and the pressure-limiting valve 42 may close again.

FIG. 1b shows a longitudinal section through the pressure-limiting valve 42 of the high-pressure fuel pump 28 of FIG. 1a. The pressure-limiting valve 42 is hydraulically arranged between the outlet 36 and a region of the high-pressure fuel pump 28 upstream of the outlet 36 and may open toward the upstream region. The pressure-limiting valve 42 or the elements thereof described in more detail hereinafter are designed in this example to be substantially rotationally symmetrical.

The pressure-limiting valve 42 comprises a housing 50 which is substantially designed as a cylindrical sleeve. The housing 50 has an axial first opening 52 on a left-hand front face in FIG. 1b, wherein a radius of the opening 52 corresponds to an inner radius of the cylindrical sleeve. The first opening 52 is hydraulically assigned to the outlet or the high pressure region downstream thereof. The housing 50 is designed to be closed on a right-hand front wall 54 in FIG. 1b. In a right-hand lower portion the housing 50 has a radial second opening 56. The second opening 56 is hydraulically assigned to said upstream region of the high-pressure fuel pump 28 and, for example, connected to the compression chamber 26. In the present case, the housing 50 is designed in one piece.

In a horizontal central portion in FIG. 1b the pressure-limiting valve 42 has a valve element 58 which is acted upon by a valve spring 60 designed as a helical spring, by means of a closing body 62 in the closing direction, i.e. to the left in FIG. 1b. In the present case, the valve element 58 is a “free flying” valve ball.

In FIG. 1b a stop body 64 of the pressure-limiting valve 42 which cooperates with the closing body 62 is arranged to the right. The stop body 64 is axially supported on the front wall 54 of the housing 50 and is acted upon by the valve spring 60 against the front wall 54 of the housing 50, i.e. to the right. To this end, a portion of the housing 50 in the region of the front wall 54 has a reduced internal diameter, whereby the stop body 64 and thus also the valve spring 60 are held in a defined manner.

A valve body 68 which is held on a radially outer lateral surface in the housing 50 by a frictional connection, and preferably impressed therein, is arranged in a left-hand portion of the housing 50 in FIG. 1b. The valve body 68 has as its inner contour 70 a continuous axial central longitudinal channel which has a uniform internal diameter in some portions. The longitudinal channel is connected hydraulically by the first opening 52 to the outlet 36. On a right-hand end portion of the longitudinal channel in FIG. 1b, a radially circumferential valve seat surface 72 which cooperates with the valve element 58 is formed on the valve body 68.

In an alternative embodiment, not shown, the housing 50 of the pressure-limiting valve 42 is an integral component of the high-pressure fuel pump 28 and thus not a separate element. In this regard, the housing 50 of the pressure-limiting valve 42 may also be a housing 50 of the high-pressure fuel pump 28. To this end, the high-pressure fuel pump 28 has, for example, a cylindrical bore in which the functional elements of the pressure-limiting valve 42 are received.

In the present example, the valve element 58 is designed as a ball. In the present example, the valve element 58 consists of tungsten carbide. Similarly, in alternative embodiments the valve element could also consist of a different wear-resistant material, for example a cermet or hard metal, or only comprise tungsten carbide or a different hard metal. Examples of other preferred hard metals are titanium carbide, tantalum carbide, chromium carbide and/or other carbides. The valve element 58 may alternatively comprise such a hard metal and also have a binding material, for example cobalt, nickel, iron, nickel-chromium and/or the like. In this example the valve body 68 consists of steel, or the valve body consists of steel and has a wear-resistant, for example hardened, surface 68, for example a hard edge layer along the valve seat surface 72 generated by carburizing and/or by nitrocarburizing.

As has emerged from investigations by the applicant, without fully opening the pressure-limiting valve 42 and also without a significant return flow of fuel from the high pressure line 44 through the pressure-limiting valve 42 into the compression chamber 26, for example by pressure pulses in the compression chamber 26 and in the high pressure line 44, it may inevitably lead to minimal openings of the pressure-limiting valve 42. Wear phenomena are associated therewith on the surfaces of the valve element 58 and the valve body 68, details thereof being discussed hereinafter.

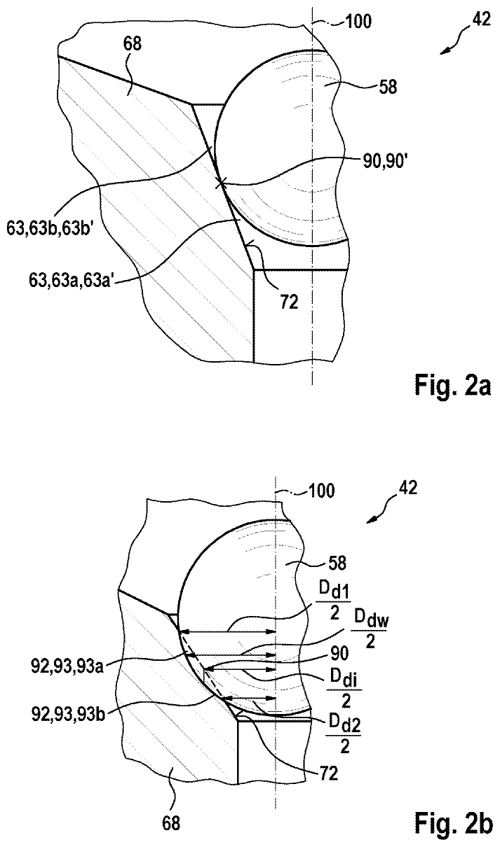

FIG. 2a shows an enlarged detail of a longitudinal section through a pressure-limiting valve 42, not according to the invention, in a state in which wear has not yet taken place.

The pressure-limiting valve 42 has a valve body 68 with a valve seat surface 72 that tapers against the opening direction 100 (the opening direction 100 faces from bottom to top along an axis of symmetry of the pressure-limiting valve 42 in FIG. 2a) of the pressure-limiting valve 42, a spherical valve element 58 and a valve spring (not illustrated) which presses the spherical valve element 58 against the opening direction 100 of the pressure-limiting valve 42 towards the valve seat surface 72. When the pressure-limiting valve 42 is closed, the valve element 58 bears against the valve seat surface 72 over a contact line 90 (which in the section shown in FIG. 2a merely appears as the contact point 90′). A gap 63 is formed between the valve element 58 and the valve body 68 next to the contact line 90.

In the case shown, the gap 63—contrary to the present invention—is as narrow symmetrically upstream of the contact line (region 63a) as downstream of the contact line (region 63b). In particular, the gap—contrary to the present invention—is as narrow symmetrically in the region relevant for wear phenomena upstream of the contact line (region 63a′) as in a region relevant for wear phenomena downstream of the contact line (region 63b′).

FIG. 2b shows the detail of FIG. 2a in a state in which significant wear has taken place. The wear has led to a removal of material on the valve seat surface 72, whilst the valve ball 58 in this example is unchanged in terms of its shape due to its high level of hardness.

The wear causes the valve ball 58 no longer to bear only at a contact line 90 against the valve seat surface but against a relatively wide annular contact region 92 which represents a wear region 93 of the valve seat surface 72 and in which the surface of the valve ball 58 is, as it were, impressed into the valve seat surface 72.

The wear region 93 may be divided into two wear regions 93a, 93b, namely into a first wear region 93a which is located substantially downstream of the previous contact line 92, and a second wear region which is located substantially upstream of the previous contact line 90. Whilst a sealing diameter D_{d1} (i.e. twice the distance in the radial direction of the valve seat surface 72 from the axis of symmetry of the pressure-limiting valve 42) in the first wear region 93a is larger than the initial diameter D_{d1} (i.e.

twice the distance in the radial direction of the contact line 90 from the axis of the pressure-limiting valve 42, see also FIG. 2a) the sealing diameter D_{d2} in the second wear region 93b is less than the initial sealing diameter D_{d1}.

For the question as to how the opening pressure pₒ of this pressure-limiting valve 42 changes due to the wear, the leakage case already described above should be taken into account, in which the pressure-limiting valve 42 is subjected to a pressure drop from the pressure prevailing in the high pressure line 44 to the pressure prevailing in the compression chamber 26 along the entire gap 63 formed between the valve element 58 and the valve body 68, wherein the pressure drop takes place, in particular, and to a particularly high degree in the wear region 93.

Investigations by the applicant have shown that an effective sealing diameter D_{dw}, and thus the force acting on the valve ball 58 with a given pressure difference in the case of wear (FIG. 2b), is increased relative to the initial sealing diameter D_{d1}. The opening pressure p_{ö} of this pressure-limiting valve 42, which is not modified according to the invention, thus drops due to the wear, for example by up to 20% over the service life of the high-pressure fuel pump 28.

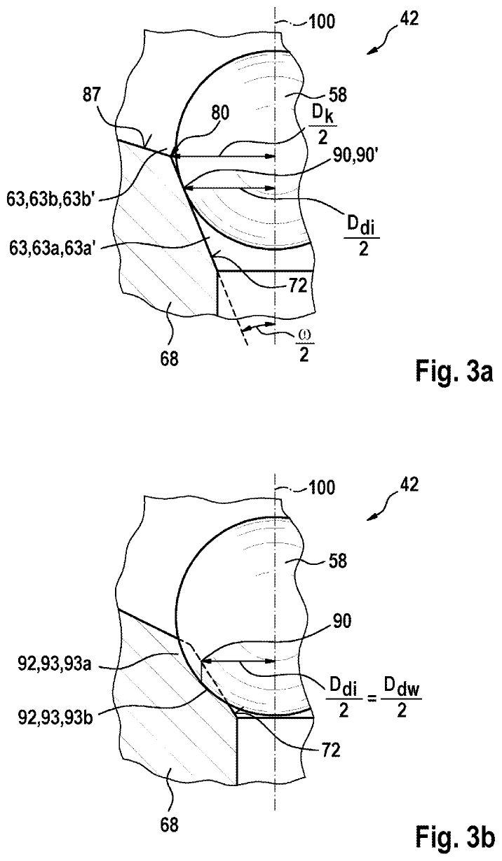

FIG. 3a shows, however, an enlarged detail of a longitudinal section through a pressure-limiting valve 42 modified according to the invention, and namely in a state in which wear has not yet taken place.

This pressure-limiting valve differs from the pressure-limiting valve 42 shown in FIG. 2a in that the gap 63 is asymmetrically narrower upstream of the contact line (region 63a) than downstream of the contact line (region 63b), in particular is narrower in a region relevant for wear phenomena upstream of the contact line (region 63a′) than in a region relevant for wear phenomena downstream of the contact line (region 63b′).

In this example, this is implemented by the valve seat surface 72 on an edge 80 of the valve body 68 striking against a further surface 87 of the valve body 68 arranged downstream of the contact line, wherein the further surface 87 is inclined further away from the opening direction 100 of the pressure-limiting valve 42 than the valve seat surface 72 and that the contact line 90 is also located in the region just upstream, but not immediately upstream, of the edge 80 of the valve body 68 on the valve seat surface 72. In the example, the contact line 90 is approximately 50 μm upstream of the edge 80 of the valve body 68, and the initial sealing diameter D_{d1} is thus approximately 65 μm less than the diameter Dₖ defined by the edge 80. In particular in FIG. 3a, the gap 63 between the valve element 58 and the valve body 68 is much wider above and radially outside the edge 80 than on the corresponding position upstream of the contact line 90.

FIG. 3b shows the pressure-limiting valve 42 of FIG. 3a in a state in which a significant wear has taken place on the valve seat surface 72 and on the further surface 87. The wear has led to a removal of material on the valve seat surface 72 and on the further surface 87, whilst in this example the valve ball 58 due to its high level of hardness is unchanged in terms of shape.

The wear causes the valve ball 58 no longer to bear only at a contact line 90 against the valve seat surface 72 but against a relatively wide annular contact region 92 which represents a wear region 93 and in which the surface of the valve ball 58 is, as it were, impressed into the valve seat surface 72.

If this wear region 93 is subdivided as above into a first wear region 93a which is located substantially downstream of the previous contact line 90 and a second wear region 93b which is located substantially upstream of the previous contact line 90, it is observed that the second wear region 93b of FIG. 3b does not substantially differ from the second wear region 93b of FIG. 2b; the first wear region 93a of FIG. 3b, however, is substantially smaller than the first wear region 93a of FIG. 2b.

Since the second wear region 93b in this embodiment is larger relative to the first wear region 93a than in the example shown in FIG. 2b, this has the result that the effective sealing diameter D_{dw} in this embodiment is also less than in the comparison example, for example equal to the initial diameter D_{d1}. With a given pressure difference, therefore, the opening force acting on the valve element 58 is less than in the comparison example, for example as high as before the wear, FIG. 3a. The opening pressure p_{ö} of the pressure-limiting valve 42 used is then unchanged compared to the new pressure-limiting valve 42, which is shown in FIG. 3a.

If the pressure-limiting valve 42, as in this example, is a ball-cone valve, specific seat angles ω (double angle between the valve seat surface and axis of symmetry; see FIG. 3a) have proved to be minimum angles for the field of application of the present invention, as a function of the ball diameter, said seat angles preferably having to be observed in order to prevent the valve ball 58 in a reliable manner from jamming in the valve seat in the new state and in the wear case. In particular, for a ball diameter of 1.588 mm: ω≥80°; for a ball diameter of 2 mm: ω≥73°; for a ball diameter of 3 mm: ω≥66°.

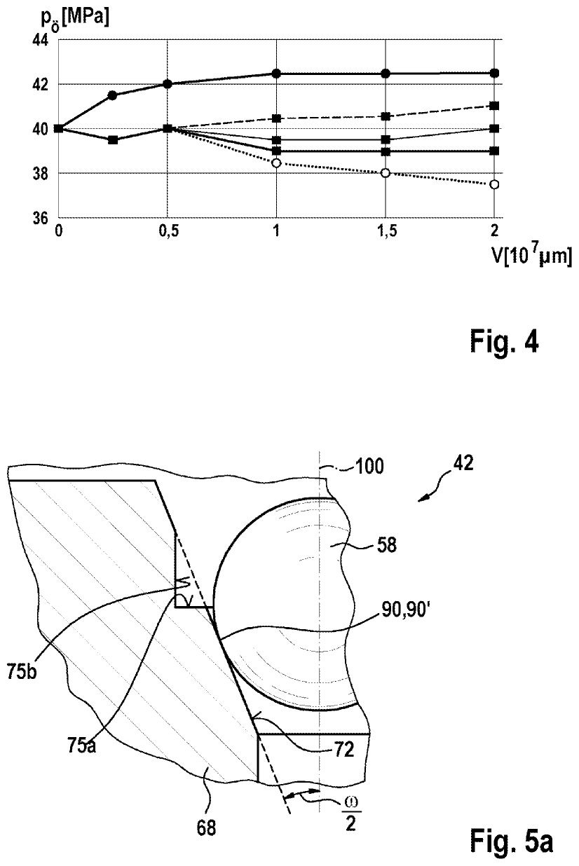

FIG. 4 shows by way of example, with the filled-in symbols for four different pressure-limiting valves 42 according to the invention, the opening pressure p_{ö} of the pressure-limiting valve 42 with increasing wear. The wear in this case is plotted on the right-hand axis of the drawing as the wear volume V with the unit 10⁷ μm³. Valve balls 58 with a diameter of 2 mm and valve seats with a seat angle of ω of ca. 74° have been used. The initial opening pressure pσ of these pressure-limiting valves 42 was 40 MPa, measured using a leakage quantity of 1.5 cm³/min. It may be seen that for all of the investigated pressure-limiting valves 42 according to the invention, the relative change of the opening pressure p_{ö} is never more than 6% of the initial opening pressure p_{ö}. In the conventional pressure-limiting valve 42 (open symbols in FIG. 4; compare FIGS. 2a and 2b), however, a reduction in the opening pressure of up to 10% of the initial opening pressure p_{ö} occurred in a comparable measurement.

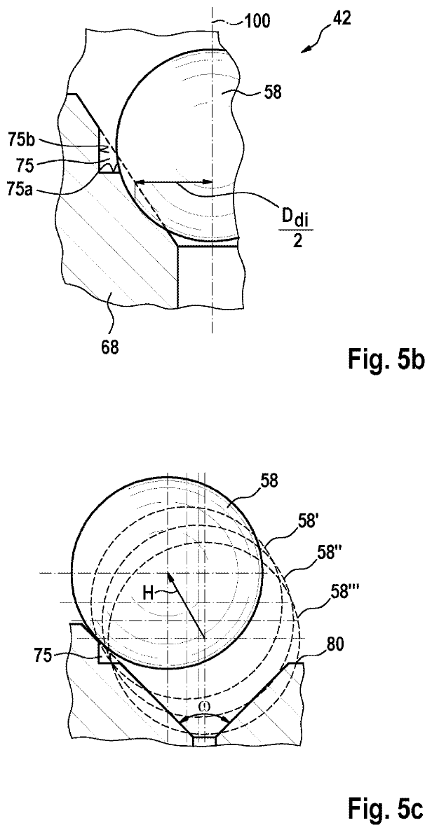

FIGS. 5a, 5b and 5c show enlarged longitudinal sections through a second exemplary embodiment of a pressure-limiting valve 42 modified according to the invention in a state in which wear has not yet taken place (FIG. 5a) and in a state in which wear has already taken place (FIGS. 5b and 5c).

In this exemplary embodiment, the invention is developed such that, just downstream of the contact line 90 between the valve element 58 and the valve seat surface 72 of the valve body 68, the valve seat surface 72 is shaped to form a recess 75 of the valve body 68. In the example, this is a rectangular recess 75, i.e. a recess 75 which consists of an annular planar surface 75awhich is perpendicular to the opening direction 100 of the pressure-limiting valve 42, and an adjoining cylindrical surface 75b which is parallel to the opening direction 100 of the pressure-limiting valve 42. The width of the annular surface 75aand the height of the cylindrical surface 75b in the example are in each case 200 pm. Downstream of the recess 75, in FIG. 5a above the recess 75, the valve seat surface 72 in this example continues in such a manner that it is located on the same straight circular cone as upstream of the recess 75.

In this configuration, even with further deflection, the valve ball 75 is reliably guided such that it safely returns into the valve seat without it resulting in potential damage to the valve seat. See FIG. 5c: if the valve ball 58 closes from large opening strokes (H), the valve ball generally strikes the valve seat offset to the axis of symmetry of the pressure-limiting valve 42 and then strikes initially downstream of the recess 75. Then it slides further into the valve seat, which is shown in FIG. 5c by the valve balls 58′, 58″ and 58′″ shown in dashed lines. The sliding of the valve balls 58 into the valve seat is only associated with a very small degree of wear, which are not able to lead to leakages of the pressure-limiting valve 42. A perpendicular impact from the position denoted in FIG. 5c by H on an unprotected edge 80 (see right-hand side in FIG. 5c), however, may potentially lead to plastic deformations of the edge 80 and thus to a reduced tightness of the pressure-limiting valve 42.

In the case of pressure-limiting valves 42 according to such a development of the invention, the measuring results shown with reference to FIG. 4 could be substantially and correspondingly reproduced.

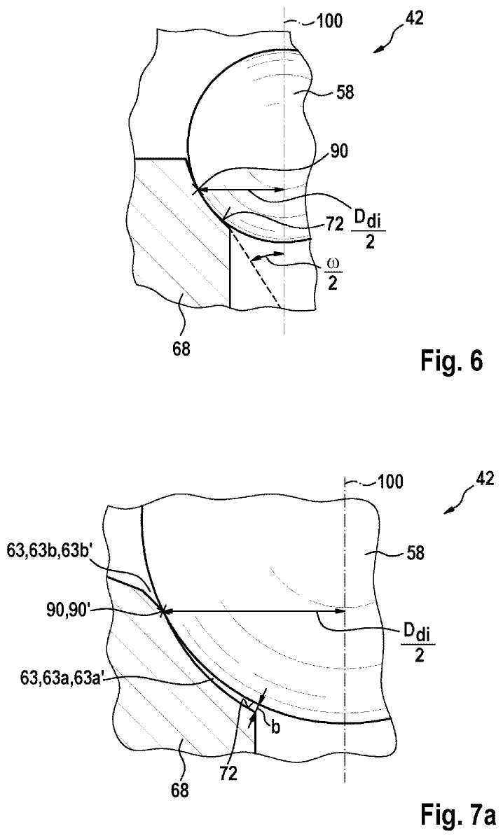

FIG. 6 shows a third exemplary embodiment. It differs from the above examples in that the valve seat surface 72 is not conical, i.e. it does not have the shape of a straight truncated cone but the shape of a dome, here a part of a ball surface, the radius thereof being greater than the radius of the valve ball 58. The dome may have been incorporated, for example, in the valve body 68 by stamping.

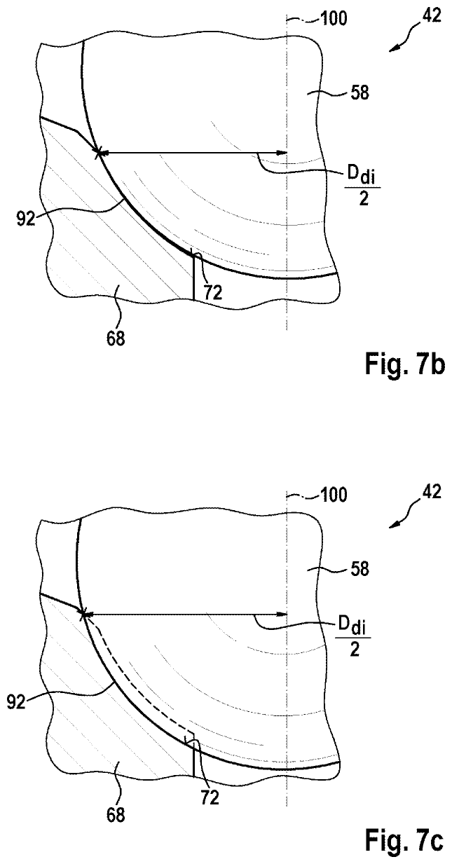

FIG. 7a shows as a fourth exemplary embodiment the pressure-limiting valve 42 of a high-pressure fuel pump in the new state. As in the third exemplary embodiment (FIG. 6) the valve seat surface 72 has a domed shape. The radius thereof is slightly larger than the radius of the spherical valve element 58. Accordingly, the gap 63 between the domed valve seat surface 72 and the spherical valve element 58 upstream of the contact line 90 is greater than zero (i.e. for example greater than 1 μm) and as small as possible. In an example, the gap 63 at the widest point is b=3 μm wide.

FIG. 7b shows the pressure-limiting valve 42 of FIG. 7a after a certain degree of wear has occurred on the valve seat surface 72. It is possible to identify the spherical valve element 58 impressed into the valve seat surface 72, so that the contact line 90 has widened to form the contact surface 92, which in the example of FIG. 7b extends over almost the entire domed region of the valve seat surface 72. Between the new state (FIG. 7a) and the wear state shown in FIG. 7b, the sealing diameter of the pressure-limiting valve 24 has only slightly changed; in the ideal case it has remained the same.

FIG. 7c shows the pressure-limiting valve 42 of FIGS. 7a and 7b after further wear has occurred on the valve seat surface 72.

It may be seen that the spherical valve element 58 is impressed slightly further into the valve seat surface 72 (but only relatively little). In this case, the sealing diameter of the pressure-limiting valve 24 has only slightly changed; in the ideal case it has remained the same. The original contour of the valve seat surface 72 in FIG. 7c is only shown for illustration.

In the context of this exemplary embodiment the gap 63 should be designed to be as small as possible, thus the gap 63 is closed even in the case of a small volume of wear, or the contact line 90 widens to form a contact surface 92, so that it extends in particular over the entire domed region of the valve seat surface 72. Then the sealing diameter changes only very slowly according to the volume of wear. The drop in opening pressure on the valve is then lower or even disappears with the same volume of wear.

1. A high-pressure fuel pump comprising:
a housing;
a compression chamber arranged in the housing;
a piston arranged displaceably in the housing and which delimits the compression chamber;
an inlet valve that opens from a low pressure region of the high-pressure fuel pump towards the compression chamber;
an outlet valve that opens from the compression chamber towards a high pressure region of the high-pressure fuel pump; and
a pressure-limiting valve that opens in an opening direction from the high pressure region of the high-pressure fuel pump towards the compression chamber or towards the low pressure region of the high-pressure fuel pump, wherein the pressure-limiting valve has comprising:
a valve body with a valve seat surface that tapers against the opening direction of the pressure-limiting valve;
a spherical valve element; and
a valve spring, which presses the spherical valve element against the opening direction of the pressure-limiting valve towards the valve seat surface,
wherein when the pressure-limiting valve is closed, the valve element and the valve seat surface bear against one another over a contact line and a gap is formed between the valve element and valve body next to the contact line, the gap being asymmetrically narrower upstream of the contact line than downstream of the contact line.

2. The high-pressure fuel pump as claimed in claim 1, wherein:
on an edge of the valve body, the valve seat surface strikes a further surface of the valve body arranged downstream of the contact line, and
the further surface is inclined further away from the opening direction of the pressure-limiting valve than the valve seat surface.

3. The high-pressure fuel pump as claimed in claim 2, wherein the contact line is located in a region just upstream, but not immediately upstream, of the edge of the valve body on the valve seat surface.

4. The high-pressure fuel pump as claimed in claim 2, wherein the further surface of the valve body is perpendicular to the opening direction of the pressure-limiting valve.

5. The high-pressure fuel pump as claimed in claim 1, wherein the valve seat surface is shaped to form a recess of the valve body just downstream of the contact line, between the valve element and the valve seat surface of the valve body.

6. The high-pressure fuel pump as claimed in claim 5, wherein the recess is a rectangular recess having an annular planar surface, which is perpendicular to the opening direction of the pressure-limiting valve, and an adjacent cylindrical surface, which is parallel to the opening direction of the pressure-limiting valve.

7. The high-pressure fuel pump as claimed in claim 1, wherein the valve seat surface has a conical or domed shape.

8. The high-pressure fuel pump as claimed in claim 5, wherein the valve seat surface has a conical or domed basic shape.

9. The high-pressure fuel pump as claimed in claim 8, wherein the valve seat surface has a shape which is produced by introducing the recess into the conical or domed basic shape.

10. The high-pressure fuel pump as claimed in claim 1, wherein the valve seat surface has a domed shape such that a portion of the gap between the domed valve seat surface and the spherical valve element upstream of the contact line is greater than zero and as small as possible.

11. The high-pressure fuel pump as claimed in claim 1, wherein the valve seat surface has a domed shape, such that a portion of the gap between the domed valve seat surface and the spherical valve element upstream of the contact line is greater than zero and the widest point of the portion of the gap is narrower than 50 μm.

12. The high-pressure fuel pump as claimed in claim 1, wherein the valve body comprises steel and has a hardened edge layer on the valve seat surface.

13. The high-pressure fuel pump as claimed in claim 1, wherein a hardness of the valve seat surface increases counter to the opening direction of the pressure-limiting valve.

14. The high-pressure fuel pump as claimed in claim 1, wherein the spherical valve element is harder than the valve body and harder than the valve seat surface.

15. The high-pressure fuel pump as claimed in claim 1, wherein the valve ball comprises a hard metal or a ceramic.

16. A pressure-limiting valve comprising:
a valve body with a valve seat surface that tapers against an opening direction of the pressure-limiting valve;
a spherical valve element; and
a valve spring, which presses the spherical valve element against the opening direction of the pressure-limiting valve towards the valve seat surface,
wherein when the pressure-limiting valve is closed, the valve element and the valve seat surface bear against one another over a contact line and a gap is formed between the valve element and valve body next to the contact line, the gap being asymmetrically narrower upstream of the contact line than downstream of the contact line.

17. The high-pressure fuel pump as claimed in claim 11, wherein the widest point of the portion of the gap is narrower than 10 μm.

18. The high-pressure fuel pump as claimed in claim 17, wherein the widest point of the portion of the gap is narrower than 5 μm.

19. The high-pressure fuel pump as claimed in claim 15, wherein the valve ball comprises tungsten carbide or silicon nitride.
